(19) United States
(12) Patent Application Publication
(10) Pub. No.: US 2026/0312350 A1
(43) Pub. Date: Oct. 8, 2026

(54) Extendable Charging Connector for Smart Shopping Cart

(71) Applicant: Maplebear Inc., San Francisco, CA (US)

(72) Inventors: Trevor Timson, Chicago, IL (US); Elizabeth Ferrall-Nunge, Oakland, CA (US); Yilin Huang, Shanghai (CN); Graham Beauregard, Burlington (CA)

(21) Appl. No.: 19/640,308

(22) Filed: Apr. 6, 2026

Related U.S. Application Data
(60) Provisional application No. 63/785,460, filed on Apr. 8, 2025.

(51) Int. Cl. H01R 31/06; B62B 3/02; B62B 3/14; H01R 13/08; H01R 13/62; H01R 13/631; H01R 13/66

(52) U.S. Cl. CPC H01R 31/065; B62B 3/02; B62B 3/1416; B62B 3/1424; H01R 13/08; H01R 13/6205; H01R 13/6315; H01R 13/6683; B62B 2202/61; B62B 2207/00; H01R 2201/26

(57) ABSTRACT

A shopping cart system includes a stackable charging system with an extendable charging connector that automatically extends and retracts based on stacking sensor data. The stackable charging system includes a male charging connector with charging pins that extend from a retracted position to an extended position to establish electrical contact with corresponding charging sockets of a female charging connector of another shopping cart. An actuator coupled to the male charging connector receives signals from an on-board computing system and controls the extension and retraction of the charging pins. The on-board computing system controls the extension and retraction based on data captured by a stacking sensor that detects whether shopping carts have stacked together. When stacking is detected, the computing system activates the actuator to extend the charging connector, and when disconnection is needed, the computing system retracts the charging connector to enable smooth cart separation.

### CROSS-REFERENCE TO RELATED APPLICATIONS

This application claims the benefit of U.S. Provisional Patent Application No. 63/785,460, filed Apr. 8, 2025, which is incorporated by reference.

### BACKGROUND

Retail environments may provide customers with smart shopping carts, which may include computing systems, sensors, cameras, and other electronic components that enable automated item identification and checkout processes. To support the electronic components, smart shopping carts require power sources, such as rechargeable batteries. Some smart shopping cart systems implement stackable charging configurations to efficiently charge multiple carts simultaneously. In these systems, shopping carts may be designed to stack together in a nested configuration, with charging connectors positioned to create electrical connections between adjacent carts in the stack. This arrangement allows power to flow from a charging station through multiple carts, enabling simultaneous charging of several units.

However, these stackable charging systems can present challenges when carts need to be unstacked for use. The charging connectors in these systems may maintain fixed connections between stacked carts, creating resistance and friction during the unstacking process. Users attempting to separate carts may encounter difficulty disconnecting the charging connections, leading to potential damage to the charging components and a worsened experience for users of these systems.

### SUMMARY

A shopping cart system includes a stackable charging system with an extendable charging connector. The stackable charging system includes a male charging connector and a female charging connector that enable electrical connections between stacked shopping carts. The male charging connector includes charging pins that extend from a retracted position to an extended position to establish electrical contact with corresponding charging sockets of the female charging connector of another shopping cart. The stackable charging system may include an actuator coupled to the male charging connector that receives signals from an on-board computing system and controls the extension and retraction of the charging pins. The charging pins and charging sockets of the charging connectors are coupled to a battery of the shopping cart to provide power transfer between stacked carts. In some embodiments, the male charging connector includes a control pin and the female charging connector includes a control socket that enable the on-board computing system to control electrical power flow between the charging connectors. The control pin may be shorter than the charging pins to ensure proper connection before power transfer begins. The stackable charging system may include an electromagnet that attracts a magnetic plate on another cart to provide mechanical connection stability during charging operations.

The on-board computing system may control the extension and retraction of the charging pins based on data captured by a stacking sensor of the shopping cart. The stacking sensor captures measurements that indicate whether shopping carts have stacked together. When the on-board computing system detects that shopping carts are stacked based on the stacking sensor data, the on-board computing system activates the actuator to move the male charging connector from the retracted position to the extended position. When the on-board computing system receives a signal to cause the carts to disconnect, such as when the battery has reached a sufficient level of charge or when a user initiates disconnection through a user interface, the on-board computing system retracts the male charging connector to the retracted position to enable smooth cart separation.

By extending and retracting the charging connector, the stackable charging system reduces the friction and resistance problems associated with fixed stackable charging connections in smart shopping carts, enabling smoother cart separation while maintaining reliable electrical connections during charging operations.

### BRIEF DESCRIPTION OF DRAWINGS

FIG. 1 illustrates an example system environment for a smart cart system, in accordance with some embodiments.

FIG. 2A illustrates the shopping cart from a rear, perspective view, in accordance with some embodiments.

FIG. 2B illustrates the shopping cart from a front, perspective view, in accordance with some embodiments.

FIG. 3 illustrates stacked shopping carts that are placed within a charging station, in accordance with some embodiments.

FIGS. 4A and 4B illustrate schematic views of shopping carts in a stacked configuration, in accordance with some embodiments.

FIG. 5 illustrates an example stackable charging system, in accordance with some embodiments.

FIG. 6 illustrates the stackable charging system where the charging pins are in an extended position, in accordance with some embodiments.

FIGS. 7 and 8 illustrate a stackable charging system with a horizontally-shaped charging pin and charging socket, in accordance with some embodiments.

### DETAILED DESCRIPTION

### Example System Environment for Smart Cart System

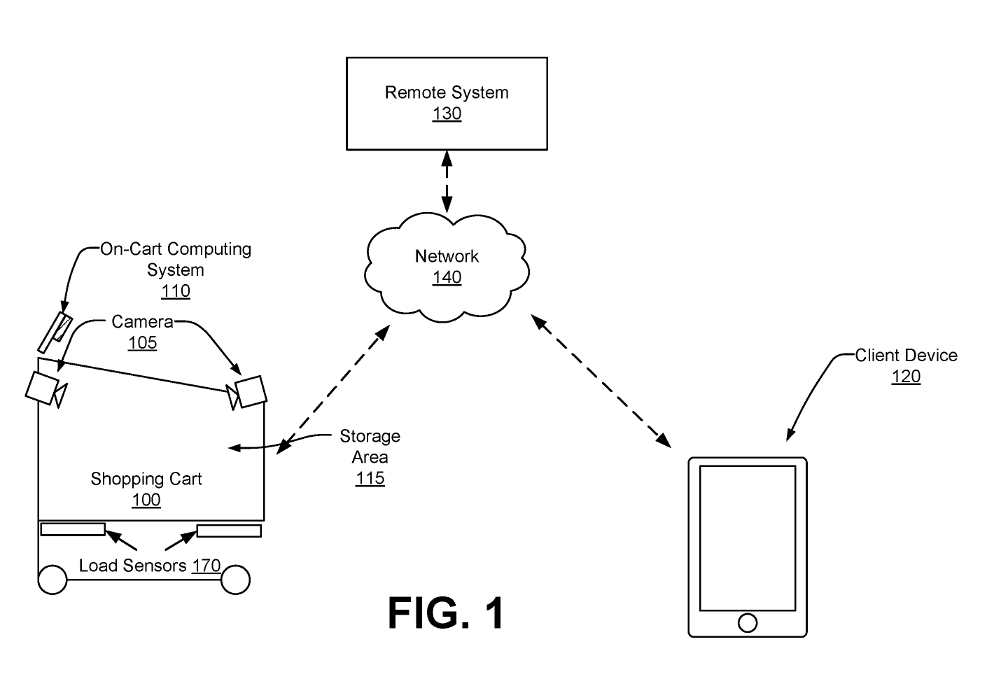

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart’s storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart’s storage area. The cameras 105 may capture two-dimensional or three-dimensional images of the shopping cart’s contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart’s storage area, or the area around the shopping cart 100. For example, the shopping cart 100 may include load sensors 170 that measure the weight of items placed in the shopping cart’s storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves – the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user’s shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. Patent Application No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. Patent Application No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user’s location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user’s shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user’s payment for the items in the shopping cart. For example, the remote system 130 may receive the user’s shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user’s actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user’s shopping list. When the shopper has gathered the items that the user has requested, the shopper may perform a checkout process through the shopping cart 100 or client device 120 to charge the user for the items. U.S. Patent No. 11,195,222, entitled “Determining Recommended Items for a Shopping List,” issued Dec. 7, 2021, describes online concierge systems in more detail, which is incorporated by reference herein in its entirety. U.S. Patent Application No. 18/963,705, entitled “Unified Embedding Model for Information Retrieval and Customization” and filed Nov. 28, 2024, describes another example online system and is incorporated by reference.

### Example Stackable Charging Shopping Cart

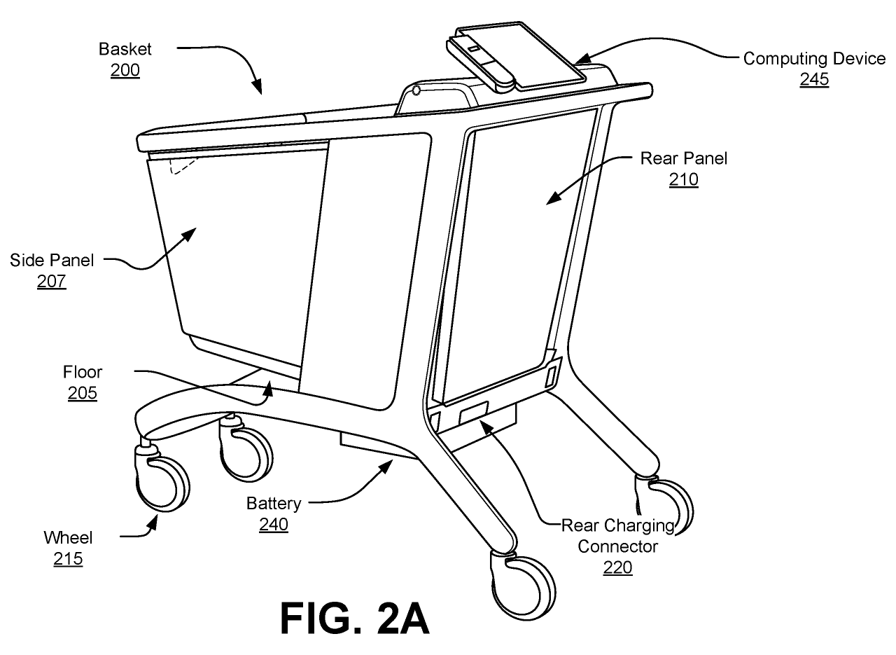

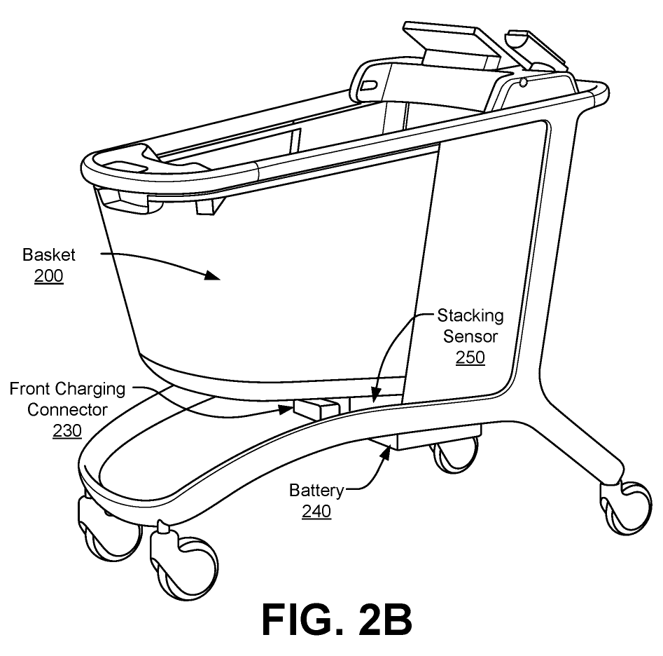

FIGS. 2A and 2B illustrate an example shopping cart with stackable charging components, in accordance with some embodiments. FIG. 2A illustrates the shopping cart from a rear, perspective view. FIG. 2B illustrates the shopping cart from a front, perspective view. Alternative embodiments may include more, fewer, or different components from those illustrated in FIGS. 2A and 2B. Additionally, the components may be located in different positions or orientations on the shopping cart, or may be structured differently, from the specific illustrated embodiment in FIGS. 2A and 2B. FIGS. 2A and 2B illustrate example embodiments of the shopping cart 100 described with regards to FIG. 1. Additional embodiments of a stackable shopping cart are described in U.S. Patent No. 12,534,119, filed Sep. 28, 2022, which is incorporated by reference.

The shopping cart includes a basket 200 that encompasses a storage area within which a user may place items for purchase. The basket 200 comprises a floor 205 that is substantially parallel to the ground and side panels 207 that are substantially orthogonal to the ground. The side panels 207 and floor 205 may comprise any of a variety of materials, such as metal, plastic, cloth, or wood. Similarly, the side panels 207 and floors 205 may be made of a solid, continuous material, or they may include perforations or formed from structures such as wires that form the panels 207 and floor 205 of the basket 200. In some embodiments, the basket 200 includes a rear panel 210 that is coupled to the shopping cart via a folding mechanism (e.g., a hinge), thereby allowing the rear panel 210 to fold into the shopping cart when another shopping cart is placed into the shopping cart. The shopping cart includes a set of wheels 215 that are coupled to the basket.

The shopping cart includes a computing device 245. The computing device 245 includes one or more processing units and one or more computer-readable media. The computing device 245 performs the functionality described above with regards to the shopping cart 100 of FIG. 1. The computing device 245 further includes a user interface, such as a display, speakers, a microphone, a keypad, a barcode scanner, or a payment interface. The computing device 245 is also coupled to the battery 240 such that the battery 240 provides power to the computing device 245. The computing device 245 may further include a networking component that allows the computing device 245 to communicate with other devices over a network (e.g., network 140). For example, the computing device 245 may include a WiFi card, an NFC card, or an RFID scanner. In some embodiments, the computing device 245 comprises a plurality of processing units located in different parts of the shopping cart. Each processing unit may be configured to perform different functionality. For example, the computing device 245 may include a CPU that controls a user interface and may include integrated circuitry that controls sensors coupled to the shopping cart. The computing device 245 further includes, or is coupled to, a stacking sensor 250 that captures measurements used to detect whether the shopping cart is stacked within another shopping cart.

The shopping cart includes a front charging connector and a rear charging connector. The rear charging connector 220 of one shopping cart is positioned to connect to the front charging connector 230 of another shopping cart stacked into the shopping cart. In some embodiments, the rear charging connector 220 includes a lid that covers the rear charging connector 220 when not connected to a front charging connector 220. The lid may be coupled to a hinge that allows the lid to move out of the way of a front charging connector 230 when the front charging connector 230 is inserted into the rear charging connector 220.

Alternative embodiments may differ from the specific embodiments illustrated in FIGS. 2A and 2B. For example, while the charging connectors 220/230 are illustrated as being coupled to the floor of the basket 200 of the shopping cart, the charging connectors 220/230 may be configured to connect in other locations on the shopping carts, such as on the side, front, or rear of the shopping cart.

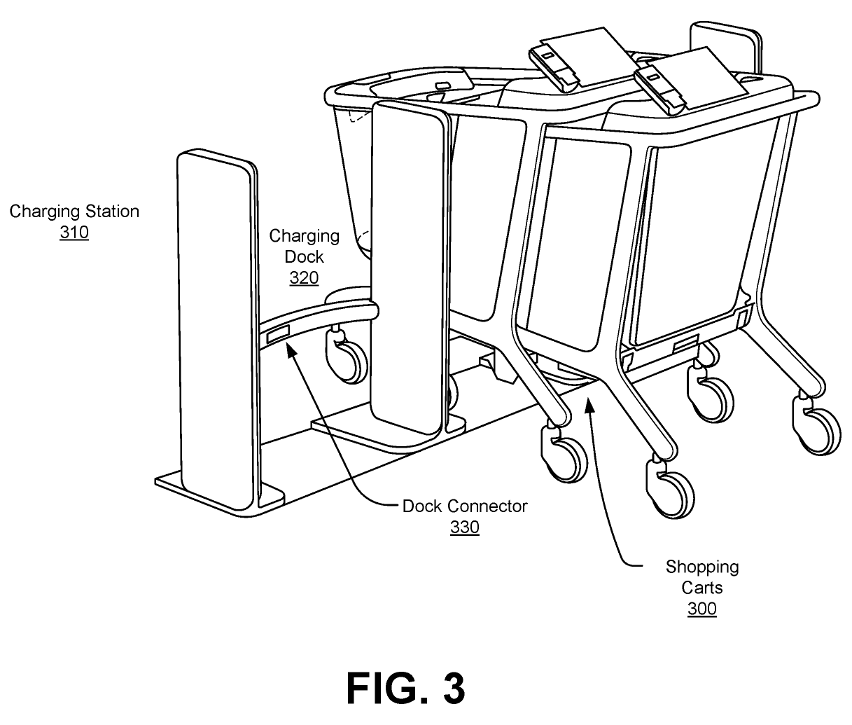

FIG. 3 illustrates stacked shopping carts 300 that are placed within a charging station 310, in accordance with some embodiments. The illustrated charging station 310 has three docks 320 within which a shopping cart may be placed, though alternative embodiments may include more or fewer docks 320 within a charging station 310. Each dock 320 includes a dock connector 330. A dock connector 330 is a connector that provides power to a set of stacked shopping carts 300. The dock connector 330 may be positioned and structured such that a front charging connector (e.g., front charging connector 230) of a shopping cart 300 is connected to the dock connector 330 when a shopping cart 300 is placed in a dock 320. In some embodiments, the dock connector 330 is substantially similar to a rear charging connector (e.g., rear charging connector 220) of a shopping cart 300.

The dock connector 330 provides power to shopping carts 300 that are stacked in the corresponding dock 320. The power from the shopping carts 300 may be evenly distributed among the shopping carts 300 that are stacked in the dock 320. Alternatively, the power may be directed towards certain shopping carts 300 such that those shopping carts 300 are charged before other shopping carts 300. For example, the shopping carts 300 may divert power from the dock connector 330 to the shopping cart 300 at the rear of the stack of shopping carts 300 such that the rear shopping cart 300 is charged before the other shopping carts 300. This ensures that the shopping cart 300 that is likely to be used next by a user is given charging priority over the other shopping carts 300.

In some embodiments, the shopping carts 300 are configured to identify whether a shopping cart 300 is stacked behind them. If a shopping cart 300 detects that another shopping cart 300 has been stacked into it, then the shopping cart 300 may be configured to route power received from the charging station 310, directly or through another shopping cart 300, to shopping carts 300 behind the shopping cart 300. If the shopping cart 300 does not detect that another shopping cart 300 is stacked into it, the shopping cart 300 may be configured to use power from the charging station 310 to charge its battery.

In some embodiments, the charging station 310 provides a cart identifier to the shopping carts 300 indicating which shopping carts 300 should be charged based on power from the charging station 310. The charging station 310 may communicate the cart identifier to shopping carts 300 stacked within a charging dock 320 e.g., through a control pin or through a network. Each shopping cart 300 stacked in the charging dock 320 may determine whether it is associated with the cart identifier. If a shopping cart 300 is not associated with the cart identifier, the shopping cart 300 routes power from the charging station 310 to the shopping carts 300 stacked into it. If the shopping cart 300 is associated with the cart identifier, the shopping cart 300 uses the power from the charging station to charge its battery.

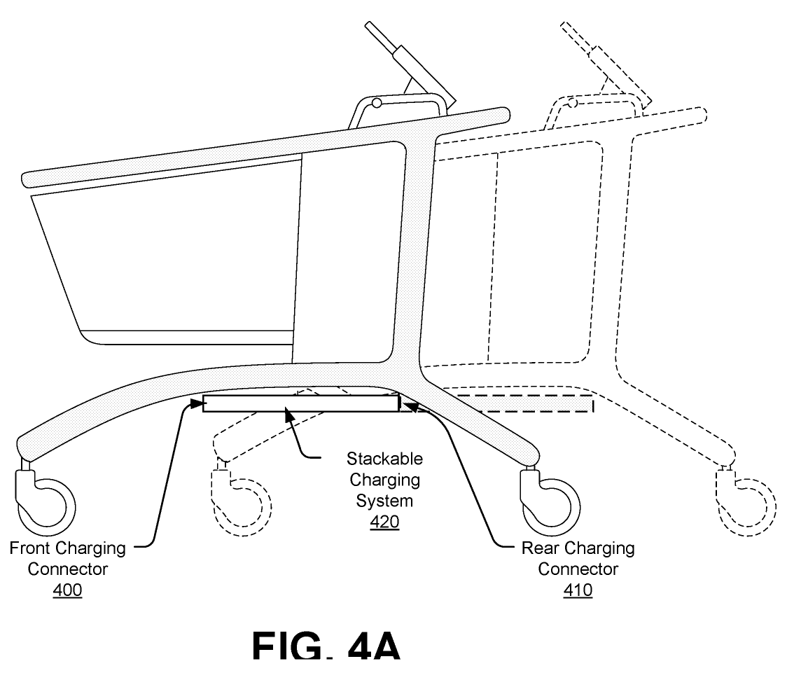

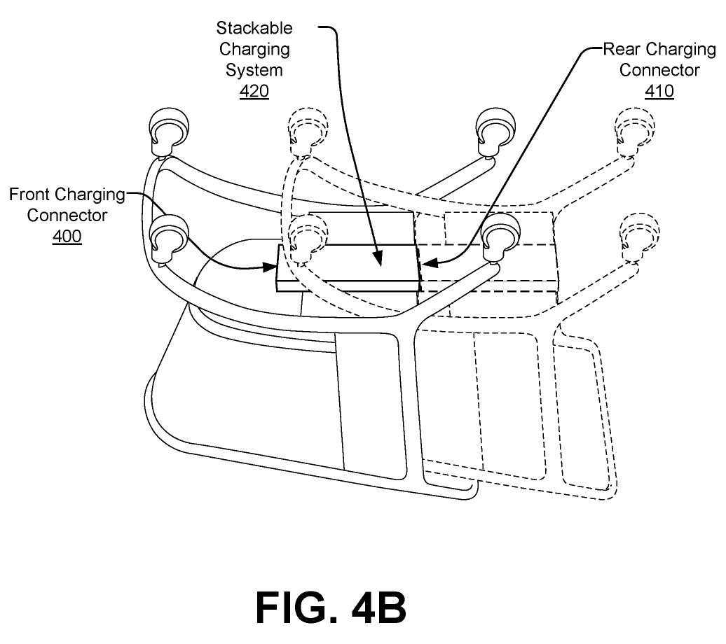

FIGS. 4A and 4B illustrate schematic views of shopping carts in a stacked configuration, in accordance with some embodiments. FIG. 4A illustrates a side, schematic view of shopping carts in a stacked configuration, and FIG. 4B illustrates a bottom-up, schematic view of the shopping carts in a stacked configuration. As illustrated in FIGS. 4A and 4B, the front charging connector 400 of the stackable charging system 420, one shopping cart is aligned with the rear charging connector 410 of the stackable charging system of the other cart.

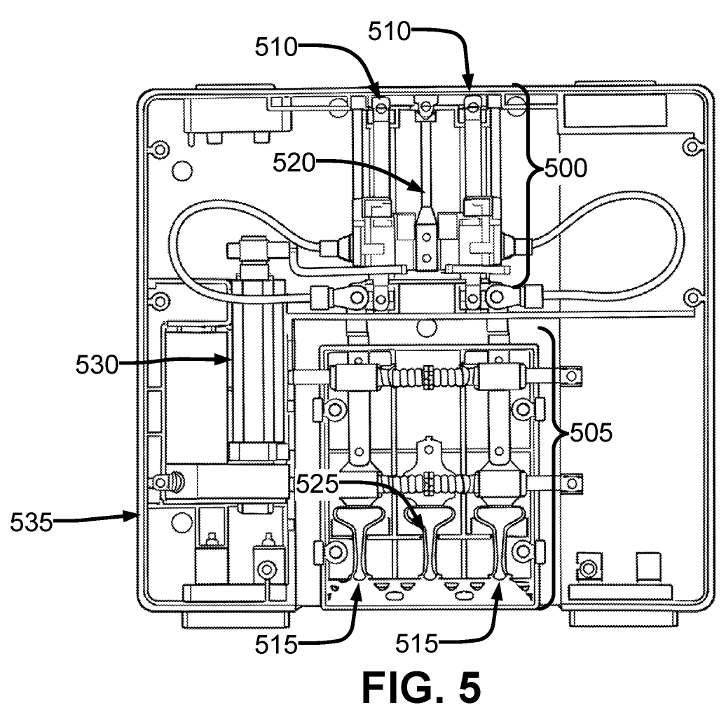

FIG. 5 illustrates an example stackable charging system, in accordance with some embodiments. Alternative embodiments may include more, fewer, or different components from those illustrated in FIG. 5. Additionally, the components may be located in different positions or orientations in the stackable charging system, or may be structured differently, from the specific illustrated embodiment in FIG. 5.

The stackable charging system includes a male charging connector 500 and a female charging connector 505. The male charging connector comprises two charging pins 510 and the female charging connector comprises two corresponding charging sockets 515. The charging pins and the charging sockets are coupled to the battery such that they are able to provide power to or receive power from the battery. In some embodiments, the charging sockets are coupled to their corresponding charging pins such that electrical power can flow from the charging sockets to the charging pins (or vice versa) without passing through the battery. The computing device may be able to control whether electrical power flowing between the charging sockets and the charging pins passes through the battery such that the battery is charged through that power.

In some embodiments, the male charging connector includes a control pin 520 and the female charging connector includes a control socket 525. The computing device may use the control pin and the control socket to control whether electrical power flows between the charging sockets and the charging pins. For example, the computing device may restrict the flow of electrical power between the charging pins and the charging sockets if the computing device does not detect that the control pin is connected with a control socket of another shopping cart. If the computing device detects that the control pin is connected to a control socket of another shopping cart, the computing device allows the flow of electrical power between the charging pins and the charging sockets. The control pin may be shorter than the charging pins, thereby ensuring that the charging pins and the charging sockets are in contact before the computing device allows power to flow. Thus, the shopping cart reduces the likelihood that arcing will occur between charging pins and charging sockets as shopping carts are connected.

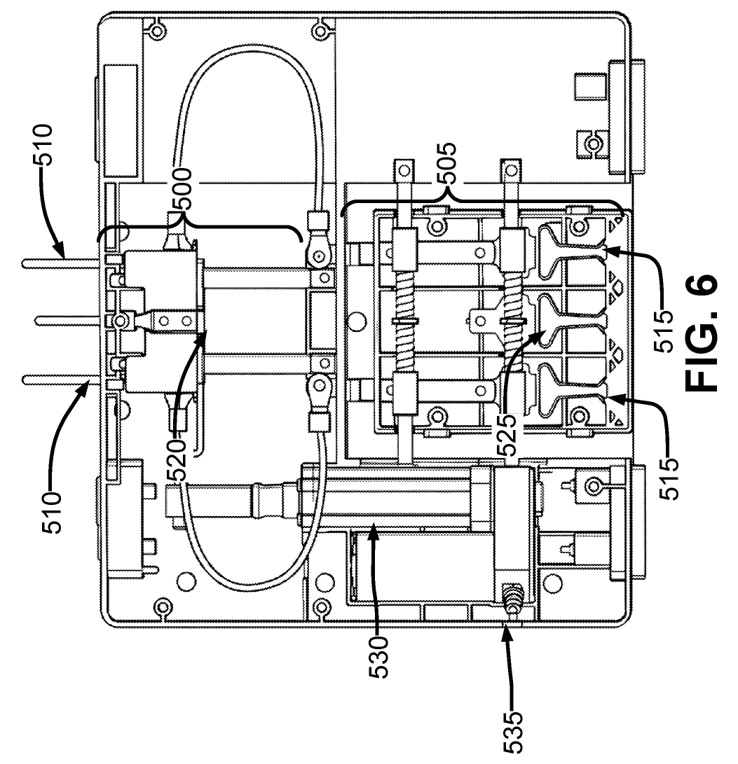

The stackable charging system includes an actuator 530 that is coupled to the male charging connector and a housing 535 for the stackable charging system. The actuator receives signals from the computing system of the shopping cart and extends or retracts the charging pins of the male charging connector based on the signals. Example actuators include linear actuators, solenoids, rotary motors with cam or lever mechanisms, rack‑and‑pinion drives, servo motors with linkage arms, cable or pulley systems, pneumatic and hydraulic cylinders, shape memory alloy actuators, and magnetic or electromagnetic push‑pull mechanisms. FIG. 5 illustrates the male charging connector in a retracted position. FIG. 6 illustrates the stackable charging system where the charging pins are in an extended position, in accordance with some embodiments.

The computing system may determine when to extend or retract the actuator based on data captured by a stacking sensor of the shopping cart. A stacking sensor is a sensor that detects when one shopping cart has been positioned within another shopping cart in a stacked configuration. The on-board computing system may use data from the stacking sensor to control the extension and retraction of the male charging connector. The stacking sensor may include various types of sensors that detect the presence or proximity of another shopping cart. For example, the stacking sensor may include proximity sensors that detect when another shopping cart approaches or contacts the shopping cart. The proximity sensors may include infrared sensors, ultrasonic sensors, or capacitive sensors that generate signals when another shopping cart is within a predetermined distance. The stacking sensor may include mechanical sensors such as pressure sensors or contact switches that activate when another shopping cart physically contacts or presses against components of the shopping cart. The stacking sensor may include optical sensors such as photoelectric sensors or laser sensors that detect interruptions in light beams when another shopping cart is stacked with the shopping cart.

In some embodiments, the stacking sensor includes a Bluetooth sensor that enables shopping carts to communicate with each other. The Bluetooth sensor may transmit and receive Bluetooth signals to detect the presence of other shopping carts in the vicinity. The on-board computing system may use the signal strength of Bluetooth signals to predict whether shopping carts are stacked together. For example, the on-board computing system may measure the received signal strength indicator (RSSI) of Bluetooth signals from nearby shopping carts. When the RSSI exceeds a predetermined threshold, the on-board computing system may determine that another shopping cart is positioned close enough to be in a stacked configuration. The on-board computing system may compare RSSI values over time to detect when another shopping cart moves into or out of stacking position. The Bluetooth sensor may also exchange identification data with other shopping carts to confirm that the detected device is indeed another shopping cart rather than a different type of Bluetooth device.

When the on-board computing system detects that shopping carts are stacked together based on data from the stacking sensor, the on-board computing system extends the male charging connector. The on-board computing system may generate control signals that activate the actuator to move the male charging connector from a retracted position to an extended position. The actuator receives these control signals and mechanically moves the charging pins of the male charging connector outward to establish electrical contact with the charging sockets of the female charging connector on the other shopping cart. The on-board computing system may monitor the position of the male charging connector during the extension process to ensure proper alignment and connection. The on-board computing system may also verify that electrical contact has been established by measuring electrical continuity or resistance between the charging pins and charging sockets.

In some embodiments, the on-board computing system activates an electromagnet when the shopping carts are detected to be stacked. The electromagnet may be positioned on the shopping cart to attract a plate of magnetic material on another shopping cart. The plate of magnetic material may include steel or other ferromagnetic materials that respond to magnetic fields. The on-board computing system may generate control signals that energize the electromagnet, creating a magnetic field that attracts the magnetic plate on the other shopping cart. The on-board computing system thereby causes the shopping carts to remain mechanically connected through magnetic attraction. The on-board computing system may activate the electromagnet before extending the charging pins to provide initial alignment and stability between the shopping carts while the male charging connector moves to the extended position. Similarly, the electromagnet may be positioned near the charging connectors to provide additional stability and alignment during the charging process.

The on-board computing system receives a signal that causes the shopping cart to disconnect from the other shopping cart. For example, the on-board computing system may monitor the battery charge level and generate a disconnection signal when the battery reaches a sufficient level of charge. The on-board computing system may compare the current battery charge level to a predetermined threshold value to determine when charging is complete. When the battery charge level exceeds the threshold, the on-board computing system may initiate a disconnection process to stop charging the battery. The on-board computing system may also receive disconnection signals from external sources such as the charging station or a remote management system. The disconnection signals may indicate that the charging session should be terminated or that the shopping cart should be made available for use by customers.

In some embodiments, the on-board computing system determines whether other shopping carts in a queue behind the shopping cart have sufficient battery levels before initiating disconnection. The on-board computing system may communicate with other shopping carts in the stacked configuration (e.g., through a control pin or through Bluetooth) to obtain their battery status information. The on-board computing system may receive battery charge level data from shopping carts positioned behind it in the charging queue. The on-board computing system may compare the battery levels of other shopping carts to predetermined minimum thresholds to determine whether those shopping carts require continued charging. The on-board computing system may delay its own disconnection process if other shopping carts in the queue have insufficient battery levels. This process ensures that power continues to flow through the current shopping cart to provide charging for shopping carts that still require electrical power.

The on-board computing system may receive user interactions through the display that request disconnection of the shopping carts. The display may present a user interface with interactive elements that allow users to control the connection status between shopping carts. For example, the display may present a button, touch screen element, or menu option that enables users to disconnect the current shopping cart from other shopping carts to which it is connected. The on-board computing system may detect user input such as button presses, touch screen contacts, or voice commands that indicate a request for disconnection. The on-board computing system may process these user inputs and generate disconnection signals in response to the user requests. The user interface may also display the current connection status and battery levels to provide users with information about the charging process.

To disconnect the shopping carts from each other, the on-board computing system retracts the male charging connector to the retracted position. The on-board computing system may generate control signals that activate the actuator to move the charging pins inward and break electrical contact with the charging sockets. The actuator receives these control signals and mechanically withdraws the charging pins of the male charging connector away from the female charging connector. The on-board computing system may monitor the retraction process to ensure that the charging pins are fully withdrawn and that electrical contact has been terminated. The on-board computing system may verify disconnection by measuring electrical continuity or resistance to confirm that no electrical path remains between the charging connectors.

The on-board computing system may deactivate the electromagnets when they were previously activated during the connection process. The on-board computing system may generate control signals that de-energize the electromagnet, removing the magnetic field that attracted the magnetic plate on the other shopping cart. The deactivation of the electromagnet releases the magnetic attraction between the shopping carts and allows them to be physically separated. In some embodiments, the on-board computing system deactivates the electromagnets after the male charging connector reaches the retracted position. This sequence ensures that the electrical connection is terminated before the magnetic connection is released. The on-board computing system may monitor the position of the male charging connector and activate the electromagnet deactivation process only after confirming that the charging pins are fully retracted.

While the charging connectors for the stackable charging system are primarily described as "male" and "female," the charging connectors are not limited to connectors that fit inside each other and are used as example embodiments. For example, the charging connectors may be magnetic connectors that use magnetic attraction to establish electrical contact between shopping carts. Similarly, the charging connectors may be inductive charging systems that transfer power wirelessly through electromagnetic fields without requiring physical contact between charging elements.

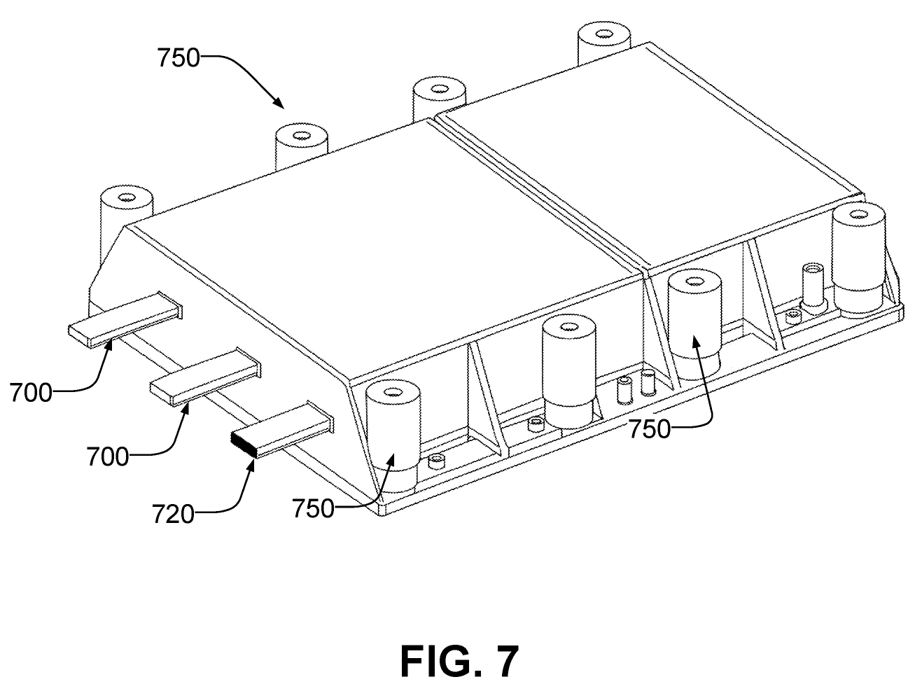

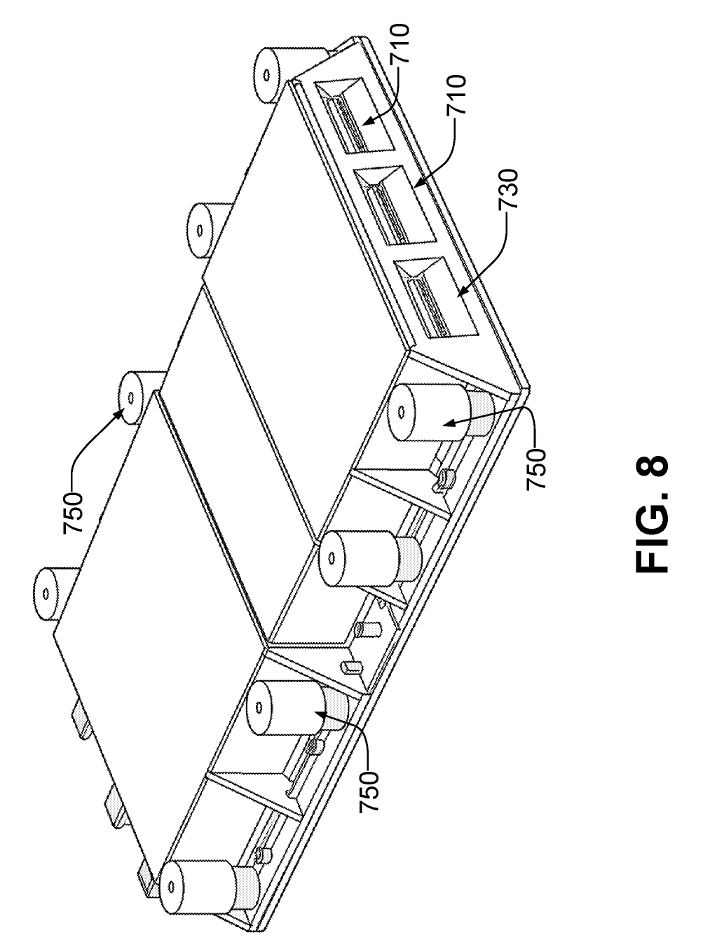

Additionally, the charging connectors may be structured differently from the specific embodiment illustrated in FIGS. 5 and 6. For example, the charging connectors may have a different shape or may have a different number or arrangement of pins or sockets. For example, FIGS. 7 and 8 illustrate a stackable charging system with a horizontally-shaped charging pin and charging socket, in accordance with some embodiments. These charging pins 700 and the charging sockets 710 are horizontally shaped, meaning the charging pins and the charging sockets have a width in a horizontal direction that is greater than a height in a vertical direction. A horizontal direction may be a direction that is substantially perpendicular to a floor of the shopping cart basket, a plane defined by wheels of the shopping cart, or a force due to gravity. Similarly, a vertical direction may be a direction that is substantially parallel to a floor of the shopping cart basket, a plane defined by wheels of the shopping cart, or a force due to gravity. In some embodiments, the control pin 720 and control socket 730 are also horizontally shaped.

In some embodiments, the stackable charging systems can float vertically to absorb vertical tolerances from horizontally-shaped charging pins and charging sockets. For example, the stackable charging system may be coupled to the floor of the shopping cart using guides 750 that enable some vertical movement of the stackable charging system. These guides may include springs that prevent the stackable charging systems from rattling while the cart is in movement but enable the stackable charging system to move as needed when connecting to another shopping cart.

The horizontally-shaped charging pins and charging sockets may be used for a stackable charging system with or without pin-extension capabilities. For example, the horizontally-shaped charging pins may be coupled to an actuator that can extend or retract the pins from the casing of the stackable charging system. Alternatively, the horizontally-shaped charging pins may be fixed in position.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied when A and B are true (or present) and C is false (or not present). Similarly, as another not-limiting example, the condition “A, B, or C” is satisfied by A is true (or present) and B and C are false (or not present).

What is claimed is:

1. A shopping cart system comprising a first shopping cart and a second shopping cart, where each of the first shopping cart and the second shopping cart comprises:
a frame;
a plurality of wheels coupled to the frame;
a battery coupled to the frame;
a male charging connector coupled to the frame, wherein the male charging connector comprises a plurality of charging prongs that are electrically coupled to the battery and actuatable between an extended and retracted position;
a female charging connector coupled to the frame, wherein the female charging connector comprises a plurality of charging sockets that are electrically coupled to the battery;
a sensor coupled to the frame; and
a computing device coupled to the frame, wherein the computing device comprises a processor and a computer-readable medium, wherein the computer-readable medium of the first shopping cart stores computer-executable instructions that, when executed, cause the processor to perform operations comprising:
receiving sensor data captured by the sensor;
detecting, based on the sensor data, that the first shopping cart and the second shopping cart are stacked together;
responsive to detecting that the first shopping cart and the second shopping cart are stacked together, actuating the charging prongs to the extended position;
detecting, while the charging prongs are in the extended position, that the charging prongs have made electrical contact with charging sockets of the second shopping cart; and
responsive to detecting that the charging prongs have made electrical contact with the charging sockets of the second shopping cart, facilitating a transfer of electrical power between the charging prongs of the first shopping cart and the charging sockets of the second shopping cart.

2. The shopping cart system of claim 1, wherein the sensor is a proximity sensor, and wherein detecting that the first shopping cart and the second shopping cart are stacked together comprises:
detecting that the second shopping cart is within a threshold distance of the first shopping cart based on the sensor data.

3. The shopping cart system of claim 1, wherein the sensor is a mechanical contact sensor, and wherein detecting that the first shopping cart and the second shopping cart are stacked together comprises:
detecting that the second shopping cart has made contact with the mechanical contact sensor.

4. The shopping cart system of claim 1, wherein the male charging connector further comprises a control pin and the female charging connector further comprises a control socket, and wherein the control pin and the control socket are communicatively coupled to the computing device.

5. The shopping cart system of claim 1, wherein the first shopping cart and the second shopping cart further comprise an actuator coupled to the male charging connector, and wherein actuating the charging prongs to the extended position comprises:
activating the actuator to extend the charging prongs to the extended position.

6. The shopping cart system of claim 5, wherein the actuator is one of: a linear actuators, a solenoid, a rotary motors with a cam mechanism, a rack-and-pinion drive, a servo motor with a linkage arm, a pneumatic cylinder, a hydraulic cylinder, a shape memory alloy actuator, or an electromagnetic push-pull mechanism.

7. The shopping cart system of claim 1, wherein the first shopping cart and the second shopping cart further comprise an electromagnet and a magnetic plate, wherein the operations further comprise:
activating the electromagnet to generate a magnetic field that magnetically couples the electromagnet to the magnetic plate of the second shopping cart.

8. The shopping cart system of claim 7, the operations further comprising:
activating the electromagnet before actuating the charging prongs to the extended position.

9. The shopping cart system of claim 1, wherein the computer-executable instructions further cause the processor to perform operations comprising:
detecting a signal to cause the first shopping cart to disconnect from the second shopping cart; and
responsive to detecting the signal to cause the first shopping cart to disconnect from the second shopping cart, actuating the charging prongs to the retracted position to disconnect the first shopping cart from the second shopping cart.

10. The shopping cart system of claim 9, wherein detecting the signal to cause the first shopping cart to disconnect from the second shopping cart comprises:
detecting that the battery has reached a threshold level of charge.

11. The shopping cart system of claim 9, wherein detecting the signal to cause the carts to disconnect comprises:
receiving a user interaction through a display of the computing device to disconnect the carts.

12. A shopping cart comprising:
a frame;
a plurality of wheels coupled to the frame;
a battery coupled to the frame;
a male charging connector coupled to the frame, wherein the male charging connector comprises a plurality of charging prongs that are electrically coupled to the battery and actuatable between an extended and retracted position;
a female charging connector coupled to the frame, wherein the female charging connector comprises a plurality of charging sockets that are electrically coupled to the battery;
a sensor coupled to the frame; and
a computing device coupled to the frame, wherein the computing device comprises a processor and a non-transitory computer-readable medium, wherein the non-transitory computer-readable medium stores computer-executable instructions that, when executed, cause the processor to perform operations comprising:
receiving sensor data captured by the sensor;
detecting, based on the sensor data, that the shopping cart and another shopping cart are stacked together;
responsive to detecting that the shopping cart and the other shopping cart are stacked together, actuating the charging prongs to the extended position;
detecting, while the charging prongs are in the extended position, that the charging prongs have made electrical contact with charging sockets of the other shopping cart; and
responsive to detecting that the charging prongs have made electrical contact with the charging sockets of the other shopping cart, facilitating a transfer of electrical power between the charging prongs of the shopping cart and the charging sockets of the other shopping cart.

13. The shopping cart of claim 12, wherein the sensor is a proximity sensor, and wherein detecting that the shopping cart and the other shopping cart are stacked together comprises:
detecting that the other shopping cart is within a threshold distance of the shopping cart based on the sensor data.

14. The shopping cart of claim 12, wherein the sensor is a mechanical contact sensor, and wherein detecting that the shopping cart and the other shopping cart are stacked together comprises:
detecting that the other shopping cart has made contact with the mechanical contact sensor.

15. The shopping cart of claim 12, wherein the male charging connector further comprises a control pin and the female charging connector further comprises a control socket, and wherein the control pin and the control socket are communicatively coupled to the computing device.

16. The shopping cart of claim 12, wherein the shopping cart comprises an actuator coupled to the male charging connector, and wherein actuating the charging prongs to the extended position comprises:
activating the actuator to extend the charging prongs to the extended position.

17. The shopping cart of claim 16, wherein the actuator is one of: a linear actuators, a solenoid, a rotary motors with a cam mechanism, a rack-and-pinion drive, a servo motor with a linkage arm, a pneumatic cylinder, a hydraulic cylinder, a shape memory alloy actuator, or an electromagnetic push-pull mechanism.

18. The shopping cart of claim 12, wherein the shopping cart comprises an electromagnet and a magnetic plate, wherein the operations further comprise:
activating the electromagnet to generate a magnetic field that magnetically couples the electromagnet to a magnetic plate of the other shopping cart.

19. The shopping cart of claim 18, the operations further comprising:
activating the electromagnet before actuating the charging prongs to the extended position.

20. The shopping cart of claim 12, wherein the computer-executable instructions further cause the processor to perform operations comprising:
detecting a signal to cause the shopping cart to disconnect from the other shopping cart; and
responsive to detecting the signal to cause the shopping cart to disconnect from the other shopping cart, actuating the charging prongs to the retracted position to disconnect the shopping cart from the other shopping cart.
